(19) United States
(12) Patent Application Publication
(10) Pub. No.: US 2022/0107650 A1
(43) Pub. Date: Apr. 7, 2022

(54) PROVIDING DELIVERIES OF GOODS USING AUTONOMOUS VEHICLES

(71) Applicant: Waymo LLC, Mountain View, CA (US)

(72) Inventors: Cameron Blume, San Francisco, CA (US); Melanie D'achon, San Francisco, CA (US); Aaron Fronk, San Mateo, CA (US); Amanda King, Chandler, AZ (US); Samrat Kansara, San Francisco, CA (US)

(21) Appl. No.: 17/223,519

(22) Filed: Apr. 6, 2021

Related U.S. Application Data
(60) Provisional application No. 63/088,209, filed on Oct. 6, 2020.

(51) Int. Cl. G05D 1/02; G05D 1/00; G06Q 10/08

(52) U.S. Cl. CPC G05D 1/0221; G05D 1/0088; G05D 2201/0213; G06Q 10/08; G05D 1/0276

(57) ABSTRACT

Aspects of the disclosure relates to providing deliveries of goods using autonomous vehicles. For instance, a first request for goods identifying a delivery location may be used to send a second request for an autonomous vehicle to deliver the goods to the delivery location. A first notification indicating that the autonomous vehicle has been loaded with the one or more goods at a loading location may be received. A second notification indicating arrival of the autonomous vehicle at the delivery location may be received. In response to receiving the second notification, a third notification may be sent indicating that the one or more goods has arrived at the delivery location. In response, a third request to open a door of the autonomous vehicle may be received. In response, a signal may be sent in order to unlock or open the door and provide access to the one or more goods.

### CROSS REFERENCE TO RELATED APPLICATIONS

The present application claims the benefit of the filing date of U.S. Provisional Application No. 63/088,209, filed Oct. 6, 2020, the disclosure of which is hereby incorporated herein by reference.

### BACKGROUND

Autonomous vehicles, for instance, vehicles that do not require a human driver, can be used to aid in the transport of passengers or items from one location to another. Such vehicles may operate in a fully autonomous mode where passengers may provide some initial input, such as a pickup or destination location, and the autonomous vehicle maneuvers itself to that location. Thus, such vehicles may be used to provide transportation services, for example, for transporting goods or people. Other systems which provide transportation services typically include drivers or conductors who are tasked with making decisions about how to operate vehicles and/or load such vehicles with goods. Such services may include some backend server systems which can dispatch vehicles to certain locations to provide transportations services as well as provide fleet management and vehicle staging instructions.

### BRIEF SUMMARY

Aspects of the disclosure provide a method of providing deliveries of goods using autonomous vehicles. The method includes receiving, by a first computing system, a first request for one or more goods for delivery, the first request further including a delivery location; sending, by the first computing system, a second request to a second computing system for an autonomous vehicle to deliver the one or more goods, the second request identifying the delivery location; receiving, by the first computing system, a first notification indicating that the autonomous vehicle has been loaded with the one or more goods at a loading location; receiving, by the first computing system, a second notification indicating arrival of the autonomous vehicle at the delivery location; in response to receiving the second notification, sending, by the first computing system, a third notification to a client computing device indicating that the one or more goods has arrived at the delivery location; in response to sending the third notification, receiving, by the first computing system, a third request to open a door of the autonomous vehicle; and in response to receiving the third request, sending, by the first computing system, a signal to the second computing system in order to unlock or open the door and provide access to the one or more goods.

In one example, the method also includes, prior to sending the second request, determining an estimated time of arrival for a plurality of delivery options. In another example, the method also includes providing to the client computing device, a plurality of delivery options including an option to receive delivery of the one or more goods by autonomous vehicle. In this example, the method also includes prior to sending the second request, receiving information corresponding to a selection of the option. In addition or alternatively, the method also includes determining that the option is available. In addition or alternatively, the method also includes, prior to sending the second request, determining whether the delivery location is within a service area for the autonomous vehicle. In another example, the method also includes receiving, from the second computing system, a fifth notification that the autonomous vehicle has been dispatched to the loading location. In this example, the method also includes, prior to receiving the second notification, receiving a fifth notification that the autonomous vehicle has arrived at the loading location. In addition or alternatively, the method also includes, receiving from the second computing system, information identifying an identifier for the autonomous vehicle. In this example, the method also includes associating an order for the one or more goods with the identifier. In addition or alternatively, the method also includes providing the identifier to the client computing device for display to a user. In another example, the method also includes receiving, from the second computing system, information identifying an estimated time of arrival for the autonomous vehicle to reach the delivery location. In this example, the method also includes providing the estimated time of arrival to the client computing device for display to a user. In another example, the method also includes receiving, from the second computing system, information identifying a current location of the autonomous vehicle and updates to the current location over time. In addition, the method also includes based on the received current location and updates to the current location, determining when the autonomous vehicle is within a predetermined distance in time or space from the delivery location. In addition, the method also includes when the autonomous vehicle is within the predetermined distance, sending a fourth notification to the client computing device. In addition or alternatively, the method also includes providing the current location and updates to the current location for display to a user. In another example, the method also includes receiving a fourth notification that an operator at the loading location has selected an option to cause the autonomous vehicle to travel from the loading location to the delivery location. In this example, the option is a button within the autonomous vehicle. In addition or alternatively, the option is provided via an application used by the operator.

### BRIEF DESCRIPTION OF THE DRAWINGS

FIG. 1 is a functional diagram of an example vehicle in accordance with an exemplary embodiment.

FIG. 2 is an example of map information in accordance with aspects of the disclosure.

FIG. 3 is an example external view of a vehicle in accordance with aspects of the disclosure.

FIG. 4 is a pictorial diagram of an example system in accordance with aspects of the disclosure.

FIG. 5 is a functional diagram of the system of FIG. 4 in accordance with aspects of the disclosure.

FIGS. 6-9 are an example overview of various aspects of a method for providing deliveries goods in accordance with aspects of the disclosure

FIG. 10 is an example flow diagram in accordance with aspects of the disclosure.

### DETAILED DESCRIPTION

### Overview

The disclosure relates to providing deliveries of goods. As an example, a first request for one or more goods for delivery may be received by a retail computing system. The first request may include a delivery location. For example, a user may place an order with a retailer and select to receive delivery of goods via an autonomous vehicle. The retailer may manage or otherwise operate the retail computing system. The retail computing system may send a second request to a dispatching computing system for an autonomous vehicle to deliver the one or more goods. The second request may identify the delivery location.

The dispatching computing system may select an autonomous vehicle and may send a signal to the selected autonomous vehicle in order to cause that selected vehicle to transport itself autonomously to a loading location. Once the autonomous vehicle has reached the loading location, an operator may load the one or more goods into the autonomous vehicle. The retail computing system may then send a second notification indicating that the autonomous vehicle has been loaded with the one or more goods at a loading location. Thereafter, the autonomous vehicle may be sent to the delivery location.

Once the autonomous vehicle is on its way to the delivery location from the loading location, the dispatching computing system may provide the retail computing system with various information about the autonomous vehicle. This may include when the autonomous vehicle has reached the delivery location. In response, the retail computing system may send a third notification to a client computing device of the user indicating that the one or more goods has arrived at the delivery location. In response to sending the third notification, the retail computing system may receive a third request to open a door of the autonomous vehicle. In response to receiving the third request, the retail computing system may send a signal to the second computing system in order to unlock or open the door and provide access to the one or more goods.

The features described herein may provide a practical and efficient way to deliver goods to a user using autonomous vehicles.

### Example Systems

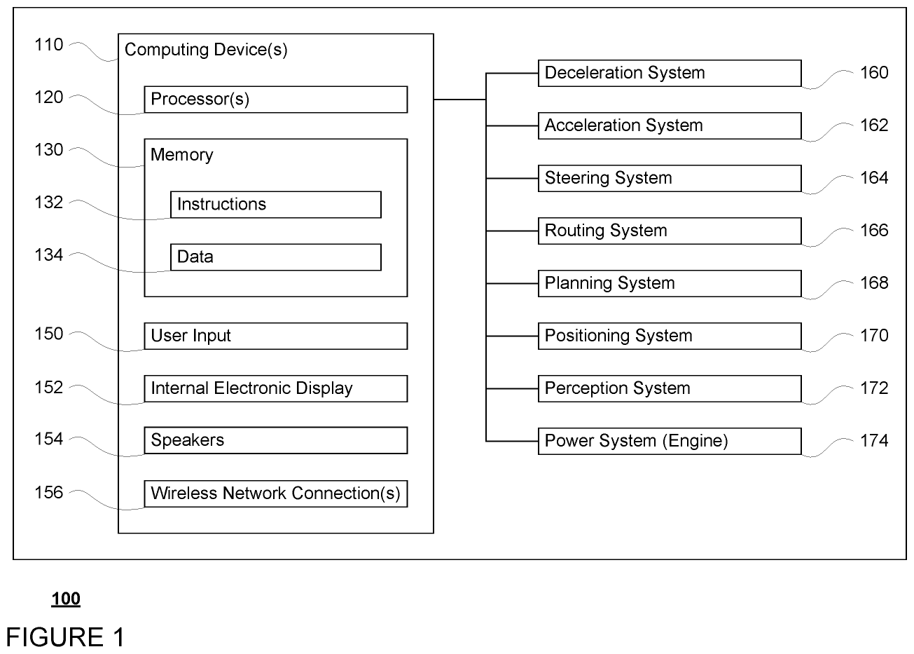

As shown in FIG. 1, an autonomous vehicle 100 in accordance with one aspect of the disclosure includes various components. While certain aspects of the disclosure are particularly useful in connection with specific types of vehicles, the autonomous vehicle may be any type of vehicle including, but not limited to, cars, trucks, motorcycles, buses, recreational vehicles, etc. The vehicle may have one or more computing devices, such as computing device 110 containing one or more processors 120, memory 130 and other components typically present in general purpose computing devices.

The memory 130 stores information accessible by the one or more processors 120, including instructions 134 and data 132 that may be executed or otherwise used by the processor 120. The memory 130 may be of any type capable of storing information accessible by the processor, including a computing device-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 134 may be any set of instructions to be executed directly (such as machine code) or indirectly (such as scripts) by the processor. For example, the instructions may be stored as computing device code on the computing device-readable medium. In that regard, the terms “instructions” and “programs” may be used interchangeably herein. The instructions may be stored in object code format for direct processing by the processor, or in any other computing device language including scripts or collections of independent source code modules that are interpreted on demand or compiled in advance. Functions, methods and routines of the instructions are explained in more detail below.

The data 132 may be retrieved, stored or modified by processor 120 in accordance with the instructions 134. For instance, although the claimed subject matter is not limited by any particular data structure, the data may be stored in computing device registers, in a relational database as a table having a plurality of different fields and records, XML documents or flat files. The data may also be formatted in any computing device-readable format.

The one or more processor 120 may be any conventional processors, such as commercially available CPUs or GPUs. Alternatively, the one or more processors may be a dedicated device such as an ASIC or other hardware-based processor. Although FIG. 1 functionally illustrates the processor, memory, and other elements of computing device 110 as being within the same block, it will be understood by those of ordinary skill in the art that the processor, computing device, or memory may actually include multiple processors, computing devices, or memories that may or may not be stored within the same physical housing. For example, memory may be a hard drive or other storage media located in a housing different from that of computing device 110. Accordingly, references to a processor or computing device will be understood to include references to a collection of processors or computing devices or memories that may or may not operate in parallel.

Computing devices 110 may include all of the components normally used in connection with a computing device such as the processor and memory described above as well as a user input 150 (e.g., one or more button, mouse, keyboard, touch screen and/or microphone), various electronic displays (e.g., a monitor having a screen or any other electrical device that is operable to display information), and speakers 154 to provide information to a passenger of the autonomous vehicle 100 or others as needed. For example, electronic display 152 may be located within a cabin of the autonomous vehicle 100 and may be used by computing devices 110 to provide information to passengers within the autonomous vehicle 100.

Computing devices 110 may also include one or more wireless network connections 156 to facilitate communication with other computing devices, such as the client computing devices and server computing devices described in detail below. The wireless network connections may include short range communication protocols such as Bluetooth, Bluetooth low energy (LE), cellular connections, as well as various configurations and protocols including the Internet, World Wide Web, intranets, virtual private networks, wide area networks, local networks, private networks using communication protocols proprietary to one or more companies, Ethernet, WiFi and HTTP, and various combinations of the foregoing.

The computing devices 110 may be part of an autonomous control system for the autonomous vehicle 100 and may be capable of communicating with various components of the autonomous vehicle in order to control the autonomous vehicle in an autonomous driving mode. For example, returning to FIG. 1, the computing devices 110 may be in communication with various systems of the autonomous vehicle 100, such as deceleration system 160, acceleration system 162, steering system 164, routing system 166, planning system 168, positioning system 170, and perception system 172 in order to control the movement, speed, etc. of the autonomous vehicle 100 in accordance with the instructions 134 of memory 130 in the autonomous driving mode.

As an example, the computing devices 110 may interact with deceleration system 160 and acceleration system 162 in order to control the speed of the autonomous vehicle. Similarly, steering system 164 may be used by computing devices 110 in order to control the direction of the autonomous vehicle 100. For example, if the autonomous vehicle 100 is configured for use on a road, such as a car or truck, the steering system may include components to control the angle of wheels to turn the autonomous vehicle. The computing devices 110 may also use the signaling system in order to signal the autonomous vehicle's intent to other drivers or vehicles, for example, by lighting turn signals or brake lights when needed.

Routing system 166 may be used by the computing devices 110 in order to generate a route to a destination. Planning system 168 may be used by computing device 110 in order to follow the route. In this regard, the planning system 168 and/or routing system 166 may store detailed map information, e.g., highly detailed maps identifying a road network including the shape and elevation of roadways, lane lines, intersections, crosswalks, speed limits, traffic signals, buildings, signs, real time traffic information, pullover spots, vegetation, or other such objects and information.

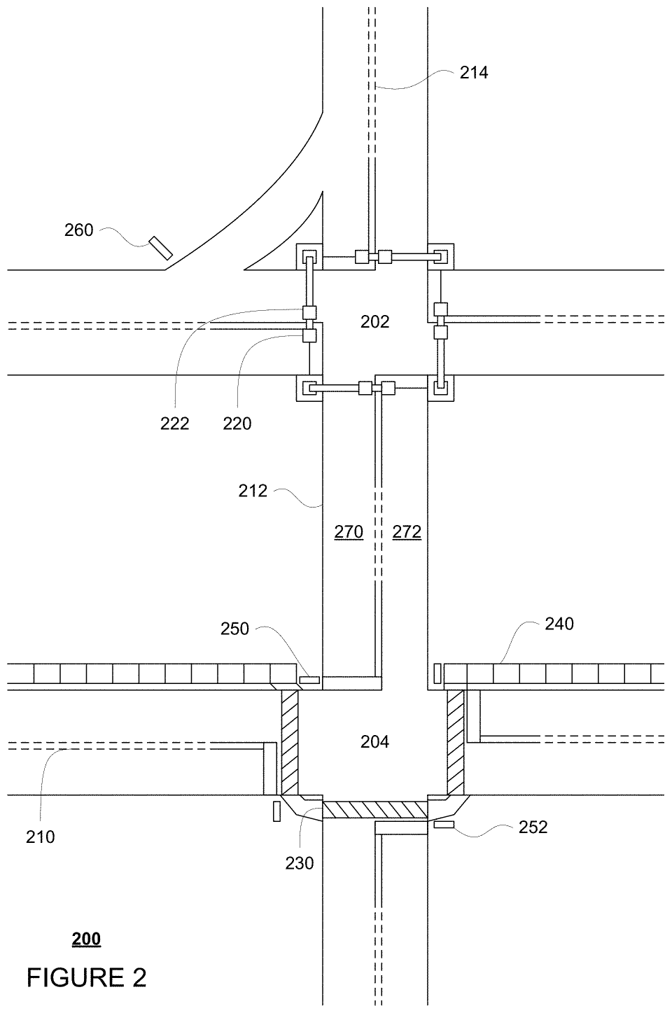

FIG. 2 is an example of map information 200 for a section of roadway including intersections 202 and 204. The map information 200 may be a local version of the map information stored in the memory 130 of the computing devices 110. Other versions of the map information may also be stored in the storage system 450 discussed further below. In this example, the map information 200 includes information identifying the shape, location, and other characteristics of lane lines 210, 212, 214, lanes 270, 272, traffic signal lights 220, 222, crosswalk 230, sidewalks 240, stop signs 250, 252, and yield sign 260.

The routing system 166 may use the map information 200 to determine a route from a current location (e.g. a location of a current node) to a destination. Routes may be generated using a cost-based analysis which attempts to select a route to the destination with the lowest cost. Costs may be assessed in any number of ways such as time to the destination, distance traveled (each edge may be associated with a cost to traverse that edge), types of maneuvers required, convenience to passengers or the autonomous vehicle, etc. Each route may include a list of a plurality of nodes and edges which the autonomous vehicle can use to reach the destination. Routes may be recomputed periodically as the autonomous vehicle travels to the destination.

Positioning system 170 may be used by computing devices 110 in order to determine the autonomous vehicle's relative or absolute position on a map or on the earth. For example, the positioning system 170 may include a GPS receiver to determine the device's latitude, longitude and/or altitude position. Other location systems such as laser-based localization systems, inertial-aided GPS, or camera-based localization may also be used to identify the location of the autonomous vehicle. The location of the autonomous vehicle may include an absolute geographical location, such as latitude, longitude, and altitude, a location of a node or edge of the roadgraph as well as relative location information, such as location relative to other cars immediately around it which can often be determined with less noise that absolute geographical location.

The positioning system 170 may also include other devices in communication with the computing devices 110, such as an accelerometer, gyroscope or another direction/speed detection device to determine the direction and speed of the autonomous vehicle or changes thereto. By way of example only, an acceleration device may determine its pitch, yaw or roll (or changes thereto) relative to the direction of gravity or a plane perpendicular thereto. The device may also track increases or decreases in speed and the direction of such changes. The device's provision of location and orientation data as set forth herein may be provided automatically to the computing device 110, other computing devices and combinations of the foregoing.

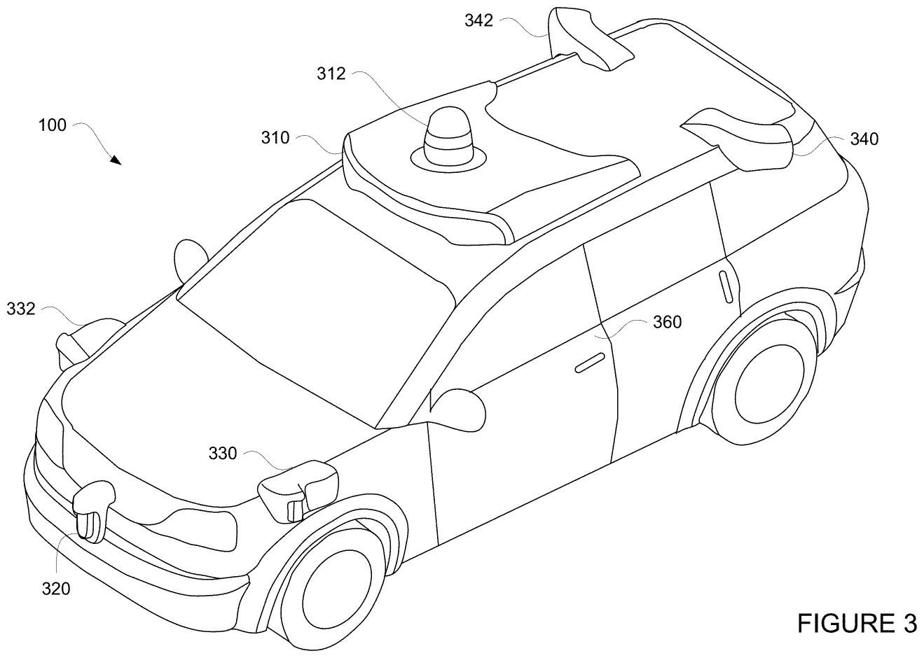

The perception system 172 also includes one or more components for detecting objects external to the autonomous vehicle such as other vehicles, obstacles in the roadway, traffic signals, signs, trees, etc. For example, the perception system 172 may include lasers, sonar, radar, cameras and/or any other detection devices that record data which may be processed by the computing devices 110. In the case where the autonomous vehicle is a passenger vehicle such as a minivan, the minivan may include a laser or other sensors mounted on the roof or other convenient location. For instance, FIG. 3 is an example external view of the autonomous vehicle 100. In this example, roof-top housing 310 and dome housing 312 may include a LIDAR sensor as well as various cameras and radar units. In addition, housing 320 located at the front end of the autonomous vehicle 100 and housings 330, 332 on the driver's and passenger's sides of the autonomous vehicle may each store a LIDAR sensor. For example, housing 330 is located in front of driver door 360. Autonomous vehicle 100 also includes housings 340, 342 for radar units and/or cameras also located on the roof of the autonomous vehicle 100. Additional radar units and cameras (not shown) may be located at the front and rear ends of the autonomous vehicle 100 and/or on other positions along the roof or roof-top housing 310.

The computing devices 110 may be capable of communicating with various components of the autonomous vehicle in order to control the movement of the autonomous vehicle 100 according to primary vehicle control code of memory of the computing devices 110. For example, returning to FIG. 1, the computing devices 110 may include various computing devices in communication with various systems of the autonomous vehicle 100, such as deceleration system 160, acceleration system 162, steering system 164, routing system 166, planning system 168, positioning system 170, perception system 172, and power system 174 (i.e. the autonomous vehicle's engine or motor) in order to control the movement, speed, etc. of the autonomous vehicle 100 in accordance with the instructions 134 of memory 130.

The various systems of the autonomous vehicle may function using autonomous vehicle control software in order to determine how to and to control the autonomous vehicle. As an example, a perception system software module of the perception system 172 may use sensor data generated by one or more sensors of an autonomous vehicle, such as cameras, LIDAR sensors, radar units, sonar units, etc., to detect and identify objects and their characteristics. These characteristics may include location, type, heading, orientation, speed, acceleration, change in acceleration, size, shape, etc. In some instances, characteristics may be input into a behavior prediction system software module which uses various behavior models based on object type to output a predicted future behavior for a detected object. In other instances, the characteristics may be put into one or more detection system software modules, such as a traffic light detection system software module configured to detect the states of known traffic signals, construction zone detection system software module configured to detect construction zones from sensor data generated by the one or more sensors of the autonomous vehicle as well as an emergency vehicle detection system configured to detect emergency vehicles from sensor data generated by sensors of the autonomous vehicle. Each of these detection system software modules may use various models to output a likelihood of a construction zone or an object being an emergency vehicle. Detected objects, predicted future behaviors, various likelihoods from detection system software modules, the map information identifying the autonomous vehicle's environment, position information from the positioning system 170 identifying the location and orientation of the autonomous vehicle, a destination location or node for the autonomous vehicle as well as feedback from various other systems of the autonomous vehicle may be input into a planning system software module of the planning system 168. The planning system 168 may use this input to generate trajectories for the autonomous vehicle to follow for some brief period of time into the future based on a route generated by a routing module of the routing system 166. In this regard, the trajectories may define the specific characteristics of acceleration, deceleration, speed, etc. to allow the autonomous vehicle to follow the route towards reaching a destination. A control system software module of the computing devices 110 may be configured to control movement of the autonomous vehicle, for instance by controlling braking, acceleration and steering of the autonomous vehicle, in order to follow a trajectory.

The computing devices 110 may control the autonomous vehicle in an autonomous driving mode by controlling various components. For instance, by way of example, the computing devices 110 may navigate the autonomous vehicle to a destination location completely autonomously using data from the detailed map information and planning system 168. The computing devices 110 may use the positioning system 170 to determine the autonomous vehicle's location and perception system 172 to detect and respond to objects when needed to reach the location safely. Again, in order to do so, computing device 110 and/or planning system 168 may generate trajectories and cause the autonomous vehicle to follow these trajectories, for instance, by causing the autonomous vehicle to accelerate (e.g., by supplying fuel or other energy to the engine or power system 174 by acceleration system 162), decelerate (e.g., by decreasing the fuel supplied to the engine or power system 174, changing gears, and/or by applying brakes by deceleration system 160), change direction (e.g., by turning the front or rear wheels of the autonomous vehicle 100 by steering system 164), and signal such changes (e.g., by lighting turn signals). Thus, the acceleration system 162 and deceleration system 160 may be a part of a drivetrain that includes various components between an engine of the autonomous vehicle and the wheels of the autonomous vehicle. Again, by controlling these systems, computing devices 110 may also control the drivetrain of the autonomous vehicle in order to maneuver the autonomous vehicle autonomously.

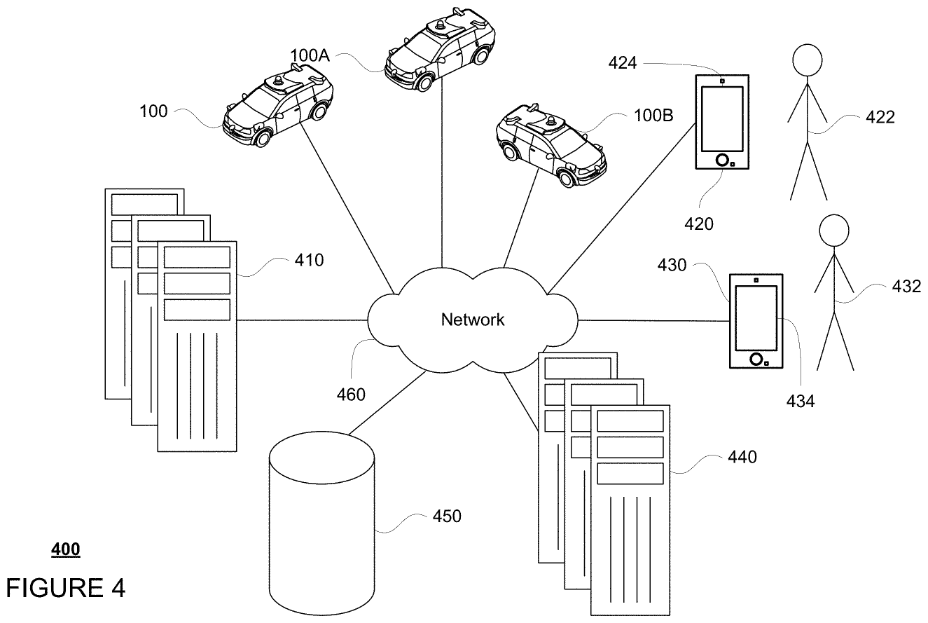

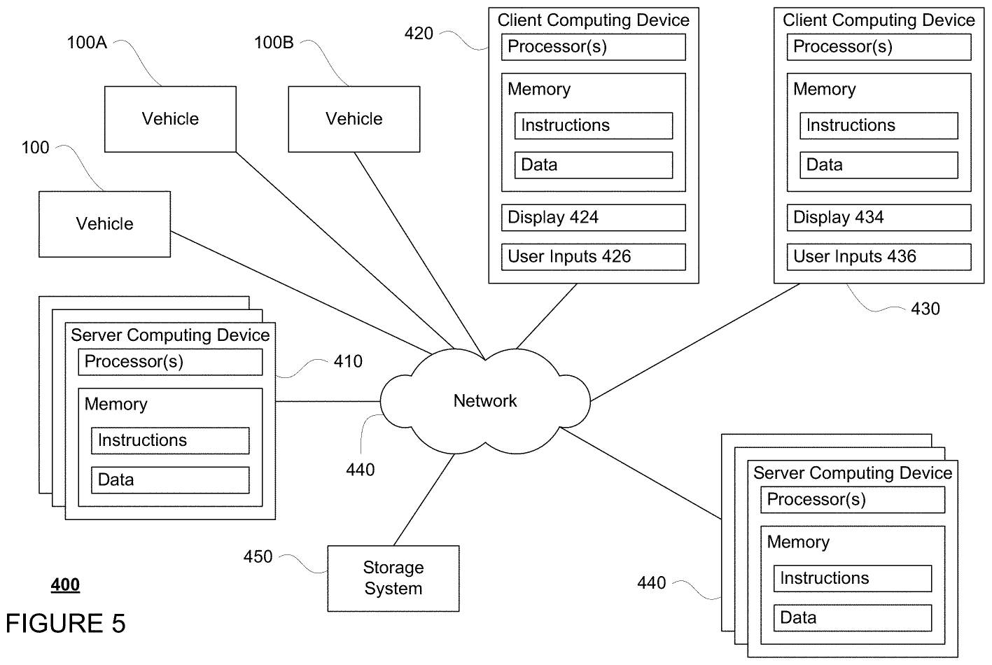

Computing device 110 of the autonomous vehicle 100 may also receive or transfer information to and from other computing devices, such as those computing devices that are a part of the transportation service as well as other computing devices. FIGS. 4 and 5 are pictorial and functional diagrams, respectively, of an example system 400 that includes a plurality of computing devices 410, 420, 430, 440 and a storage system 450 connected via a network 460. System 400 also includes the autonomous vehicle 100A and the autonomous vehicle 100B, which may be configured the same as or similarly to the autonomous vehicle 100. Although only a few vehicles and computing devices are depicted for simplicity, a typical system may include significantly more.

As shown in FIG. 5, each of computing devices 410, 420, 430, 440 may include one or more processors, memory, data and instructions. Such processors, memories, data and instructions may be configured similarly to one or more processors 120, memory 130, data 132, and instructions 134 of computing device 110.

The network 460, and intervening graph nodes, may include various configurations and protocols including short range communication protocols such as Bluetooth, Bluetooth LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

In one example, one or more computing devices 410 may include one or more server computing devices having a plurality of computing devices, e.g., a load balanced server farm, that exchange information with different nodes of a network for the purpose of receiving, processing and transmitting the data to and from other computing devices. For instance, one or more computing devices 410 may include one or more server computing devices that are capable of communicating with computing device 110 of the autonomous vehicle 100 or a similar computing device of the autonomous vehicle 100A or the autonomous vehicle 100B as well as computing devices 420, 430, 440 via the network 460. For example, autonomous vehicles 100, 100A, 100B, may be a part of a fleet of vehicles that can be dispatched by server computing devices to various locations. In this regard, the server computing devices 410 may function as a dispatching computing system 410 (hereafter dispatching computing system 410) which can be used to dispatch vehicles such as autonomous vehicles 100, 100A, 100B to different locations in order to pick up and drop off passengers as well as to generate and track scouting quests and objectives as discussed further below. In addition, the dispatching computing system 410 may use network 460 to transmit and present information to a user, such as user 422, 432 on a display, such as displays 424, 434 of computing devices 420, 430. In this regard, computing devices 420, 430 may be considered client computing devices.

The dispatching computing system 410 may be configured to select vehicles for ride or transport services depending upon locations of the autonomous vehicles, passengers and/or goods (e.g. cargo), destinations, etc. This information, including the locations of the autonomous vehicles, status of passengers and/or goods, destinations, etc. may be tracked, for instance, in a status table of the storage system 450. In this regard, all or part of the storage system 450 may be remote from or part of dispatching computing system 410. The dispatching computing system 410 may also track the state of the autonomous vehicles using information that is periodically broadcast by the autonomous vehicles, specifically requested by the dispatching computing system 410 and provided by the autonomous vehicles, or using other methods of tracking the states of a fleet of autonomous vehicles. This periodically broadcast information may include messages providing all state information for a given vehicle. For instance state messages may be self-consistent and generated based on rules about packaging the messages from various systems of the autonomous vehicles. As an example, the messages may include vehicle pose, lane information (i.e., in what lane the autonomous vehicle is currently traveling), as well as other information, such as whether the autonomous vehicle is currently providing transportation services, experiencing any errors or problems, etc.

Other computing systems, such as the retail computing system 440, may also be configured to communicate with the dispatching computing system 410. The retail computing system, for example, may be managed and/or operated by a retailer of various goods, e.g. a grocer, clothing, sporting, or any other type of retail business. The retail computing system may send and receive notifications and requests with the dispatching computing system 410 via the network 460 as discussed further below. The retail computing system may track order made by users as well as the status of the delivery of those orders. This information may be tracked, for instance, in a status table of the storage system 450 and/or another storage system.

As shown in FIG. 5, each client computing device 420, 430 may be a personal computing device intended for use by a user 422, 432 and have all of the components normally used in connection with a personal computing device including a one or more processors (e.g., a central processing unit (CPU)), memory (e.g., RAM and internal hard drives) storing data and instructions, a display such as displays 424, 434 (e.g., a monitor having a screen, a touch-screen, a projector, a television, or other device that is operable to display information), and user input devices 426, 436 (e.g., a mouse, keyboard, touchscreen or microphone). The client computing devices may also include a camera for recording video streams, speakers, a network interface device, and all of the components used for connecting these elements to one another.

Although the client computing devices 420, 430 may each comprise a full-sized personal computing device, they may alternatively comprise mobile computing devices capable of wirelessly exchanging data with a server over a network such as the Internet. By way of example only, client computing device 420 may be a mobile phone or a device such as a wireless-enabled PDA, a tablet PC, a wearable computing device or system, or a netbook that is capable of obtaining information via the Internet or other networks. In another example, client computing device 430 may be a wearable computing system, such as a wristwatch. As an example the user may input information using a small keyboard, a keypad, microphone, using visual signals with a camera, or a touch screen.

In some examples, client computing device 420 may be a mobile phone used by passenger of a vehicle. In other words, user 422 may represent a user who purchases one or more goods from a retailer, while user 432 may represent an operator (hereafter operator 432) who works for the retailer, the transportation service, or a fulfillment service. The client computing device 430 may represent a workstation for the operator, for example, someone who is responsible for loading one or more goods into an autonomous vehicle. Although only a single user and operator are shown in FIGS. 4 and 5, any number of such passengers and remote assistance operators (as well as their respective client computing devices) may be included in a typical system.

As with memory 130, storage system 450 can be of any type of computerized storage capable of storing information accessible by the dispatching computing system 410, such as a hard-drive, memory card, ROM, RAM, DVD, CD-ROM, write-capable, and read-only memories. In addition, storage system 450 may include a distributed storage system where data is stored on a plurality of different storage devices which may be physically located at the same or different geographic locations. Storage system 450 may be connected to the computing devices via the network 460 as shown in FIGS. 4 and 5, and/or may be directly connected to or incorporated into any of the computing devices 110, 410, 420, 430, 440, etc.

Storage system 450 may store various types of information as described in more detail below. This information may be retrieved or otherwise accessed by a server computing device, such as one or more server computing devices of the dispatching computing system 410, in order to perform some or all of the features described herein.

### Example Methods

In addition to the operations described above and illustrated in the figures, various operations will now be described. It should be understood that the following operations do not have to be performed in the precise order described below. Rather, various steps can be handled in a different order or simultaneously, and steps may also be added or omitted.

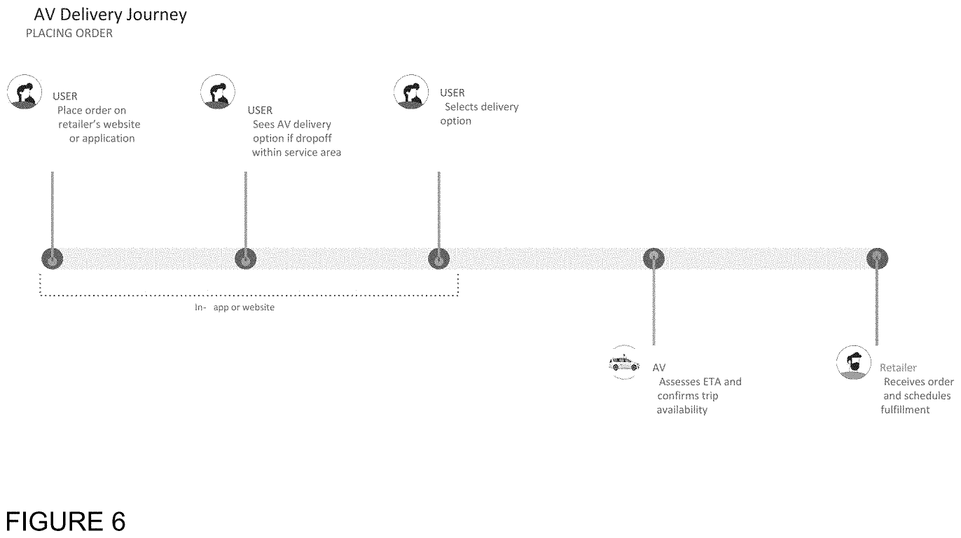

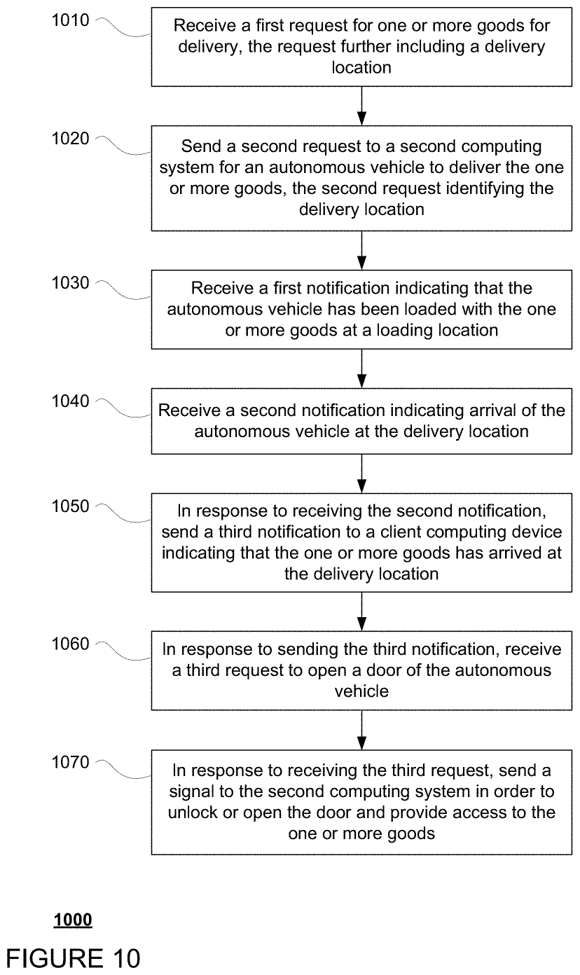

FIGS. 6-9 provide an overview of various aspects of a method for providing deliveries of goods in accordance with aspects of the disclosure. FIG. 10 is an example flow diagram 1000 for providing deliveries of goods using autonomous vehicles which may be performed by a computing system, such as the retail computing system 440. Turning to block 1010, a first request for one or more goods for delivery is received. The first request also includes a delivery location.

Turning to FIG. 6, a user, such as user 422, may download and access an application or a website of a retailer using a client computing device, such as client computing device 420. While placing an order, the application and/or website may send and receive information with the retail computing system 440, such as the identification of goods and a delivery location provided by the user 422. The retail computing system 440 may determine a plurality of delivery options for the one or more goods, for example, by determining whether the delivery location is within a service area or other capabilities for the autonomous vehicles of the fleet. If so, an option to receive delivery by autonomous vehicles may be provided to the client computing device 420. This option may be provided with other options such as delivery by a human driver, mail or other typical shipping options.

In addition, the retail computing system 440 may determine an estimated time of arrival for each of the delivery options. This may be determined, for example, by requesting an estimate from the dispatching computing system 410, and/or using predetermined tables or charts which identify how long different shipping options might take. By doing so, the retail computing system 440 may also confirm with the dispatching computing system 410 that an autonomous vehicle is or will be available to deliver the one or more goods. The user 422 may then select one of the plurality of options, and this information may be sent to the retail computing system 440 via the network 460. In response, the retail computing system 440 may receive the order and set up fulfillment of the order, or rather, initiate the delivery of the one or more goods.

In order to fulfill the order, the retail computing system 440 may send a fulfillment request or a notification identifying the goods and the delivery location. This notification may be sent to a human operator of the retailer, the transportation service, or a third-party fulfillment service. This human operator may initiate the retrieval of the goods (e.g. by entering information into a fulfillment system and/or by gathering them). In some instances, the third-party fulfillment service may make additional decisions (automatically via one or more computing device or by a human operator) about how to aggregate fulfillment of multiple requests.

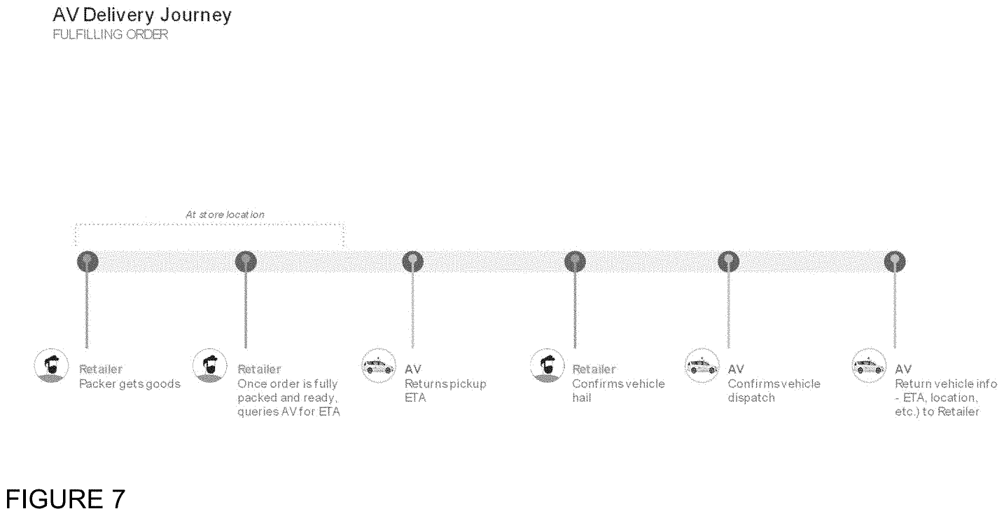

Turning to FIG. 7, in order to fulfil the order, an operator, such as operator 432, may retrieve (e.g. gather) the one or more goods from the order and get them ready for loading. At that point, the operator 432 may use an application or website on his or her client computing device, such as client computing device 430, to confirm that this has been completed. The application or website used by the operator 432 may be the same or a different application used by the user 422.

This confirmation may cause a notification to be sent to the retail computing system 440 which may respond by sending a request for an autonomous vehicle to deliver the one or more goods to the dispatching computing system 410. This request may identify the delivery location for the one or more goods.

Returning to FIG. 10, at block 1020, a second request is sent to a second computing system for an autonomous vehicle to deliver the one or more goods. The second request identifies the delivery location. For example, if the user 422 selects delivery by autonomous vehicle, the retail computing system 440 may send a request to the dispatching computing system 410 for an autonomous vehicle to deliver the one or more goods. As noted above, the dispatching computing system 410 may select an appropriate autonomous vehicle of the fleet. Such as autonomous vehicles 100, 100A or 100B, for example, one that is available (e.g. not otherwise engaged on a trip, etc.) and has a service area within which the delivery location is located.

In some instances, the selection of an appropriate autonomous vehicle may be based on characteristics of the goods themselves. For example, some goods may not be small enough to fit inside a typical class 1 passenger vehicle. In this regard, for larger deliveries such as those for business to business translations may require a larger vehicle such as a class 4-6 truck.

Once an autonomous vehicle is selected, the dispatching computing system 410 may provide the retail computing system 440 with various information about the autonomous vehicle. This may include an identifier for the autonomous vehicle, a current location of the autonomous vehicle, a route the autonomous vehicle is currently following, as well as an estimated time of arrival for the autonomous vehicle to reach the loading location. The current location and route may be provided to the dispatching computing system 410 by the autonomous vehicle as described above. This estimated time of arrival may be estimated by the dispatching computing system 410, for instance, using the map information and a routing system similar to the routing system of the autonomous vehicle 100 or another navigation. Alternatively, the estimated time of arrival may be determined by the routing system of the selected autonomous vehicle and sent to the dispatching computing system 410, which in turn, may provide the estimated time of arrival to the routing system.

In addition, the dispatching computing system 410 and/or the retail computing system 440 may send one or more notifications to the client computing device of an operator. For example, such notifications may be sent to the client computing device 430 of the operator 432 or another client computing device of another operator who will be loading the goods into the assigned autonomous vehicle. These notifications may provide the operator and/or the another operator with updates about the status of the vehicle (e.g. a current location of the autonomous vehicle, a route the autonomous vehicle is currently following, as well as an estimated time of arrival for the autonomous vehicle to reach the loading location). In addition or alternatively, the notifications may provide an embedded link to a website which when accessed will provided such updates and/or additional details. These notifications may be delivered via short messaging service (SMS), automated phone calls or other notifications via the application at the client computing device used by the operator and/or another operator.

In response, the retail computing system 440 may automatically send a confirmation to the dispatching computing system 410 and/or the confirmation may be initiated by the operator 432 using the application or website. This confirmation may cause the dispatching computing system 410 to send a signal to the selected autonomous vehicle in order to cause that selected vehicle to transport itself autonomously to a loading location using the various systems of the autonomous vehicle as described above. In some instances, the autonomous vehicle may send a signal back to the dispatching computing system 410 confirming that the autonomous vehicle is on its way to the loading location.

The dispatching computing system 410 may also provide the retail computing system 440 with updated information about the autonomous vehicle's current location and route as it travels towards the loading location and also when the autonomous vehicle has reached the loading location. As noted above, this information may be reported to the dispatching computing system 410 periodically from the autonomous vehicle. The retail computing system 440 may use the received information to track the location of the autonomous vehicle as it travels towards the loading location. In addition, the retail computing system 440 may associate the identifier with the order and may also provide the identifier to the client computing device 420 for display to the user 422. In some instances, the retail computing system 440 may also send information to the client computing devices 420, 430 about the autonomous vehicle's current location (including updates to this current location over time), route, and when the autonomous vehicle has reached the landing location. This information may then be displayed to the user 422 and/or the operator 432 on his or her respective client computing devices 420, 430.

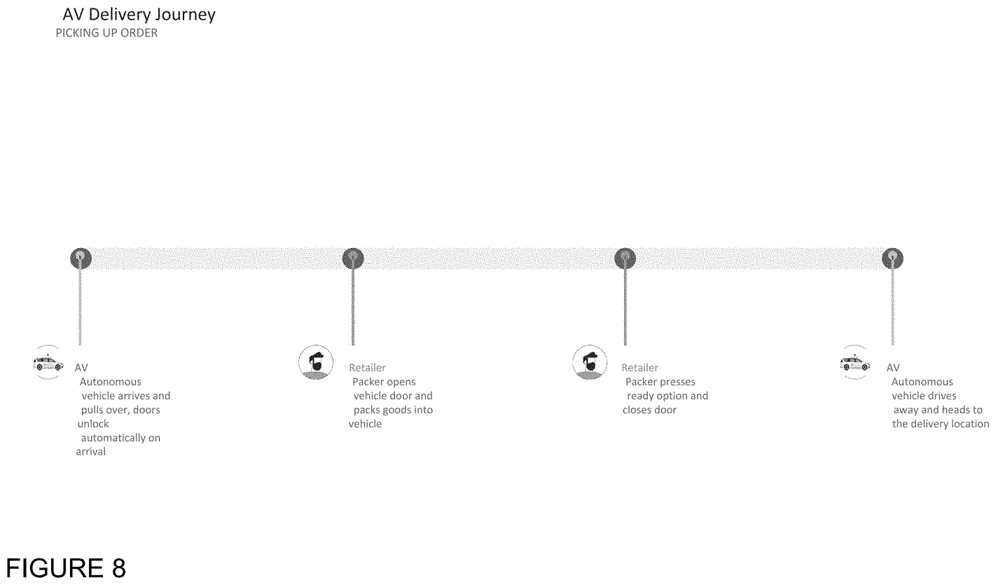

Turning to FIG. 8, once the autonomous vehicles has reached the loading location, it may pullover (e.g. come to a stop). In some instances, the autonomous vehicle may also automatically unlock its doors. At this point, the operator 432 (or another operator) may load the one or more goods into the autonomous vehicle.

Returning to FIG. 10, at block 1030, a first notification indicating that the autonomous vehicle has been loaded with the one or more goods at a loading location is sent. For instance, after the operator 432 has loaded the one or more goods, the operator 432 may use the application or website on his or her client computing device 430 to confirm that this has been completed. This may cause the application or website to send a notification indicating that the autonomous vehicle has been loaded with the one or more goods at the loading location.

In addition or alternatively, the operator 432 may also select a “ready” option, for example, via the application or website or a button of the autonomous vehicle (such as user input 150), to confirm that the autonomous vehicle is ready to begin a trip to the delivery location. Selecting this option may dispatch or cause the autonomous vehicle to travel from the loading location to the delivery location. In response, if using the client computing device 430, the application or website may send a notification indicating the same to the retail computing system 440 confirming that the autonomous vehicle has been dispatched to the delivery location. Alternatively, if a button within the autonomous vehicle is used, the autonomous vehicle may send a signal to the dispatching computing system 410 indicating that the autonomous vehicle is now traveling from the loading location to the delivery location. In turn, the dispatching computing system 410 may send a notification of the same to the retail computing system 440 confirming that the autonomous vehicle has been dispatched to the delivery location. In the former case, the operator 432 may close the door before selecting the option, and in the latter case, the operator may close the door after selecting the option.

Once the autonomous vehicle is on its way to the delivery location from the loading location, the dispatching computing system 410 may again provide the retail computing system 440 with various information about the autonomous vehicle. This may include a current location of the autonomous vehicle, a route currently being followed by the autonomous vehicle, as well as an estimated time of arrival for the autonomous vehicle to reach the delivery location. The current location and route may be provided to the dispatching computing system 410 by the autonomous vehicle as described above. This estimated time of arrival may be estimated by the dispatching computing system 410, for instance, using the map information and a routing system similar to the routing system of the autonomous vehicle 100 or another navigation system. Alternatively, the estimated time of arrival may be determined by the routing system of the selected autonomous vehicle and sent to the dispatching computing system 410, which in turn, may provide the estimated time of arrival to the routing system. The dispatching computing system 410 may also provide updated information about the autonomous vehicle's current location and route as it travels towards the delivery location and also when the autonomous vehicle has reached the delivery location.

The retail computing system 440 may use the received information to track the location of the autonomous vehicle as it travels towards the delivery location. In some instances, the retail computing system 440 may also send information to the client computing device 420 about the autonomous vehicle's current location (including updates to this current location over time), route, and when the autonomous vehicle has reached the delivery location. This information may then be displayed to the user 422. For example, these notifications may provide the user with updates about the status of the vehicle (e.g. a current location of the autonomous vehicle, a route the autonomous vehicle is currently following, as well as an estimated time of arrival for the autonomous vehicle to reach the delivery location). In addition or alternatively, the notifications may provide an embedded link to a website which when accessed will provided such updates and/or additional details.

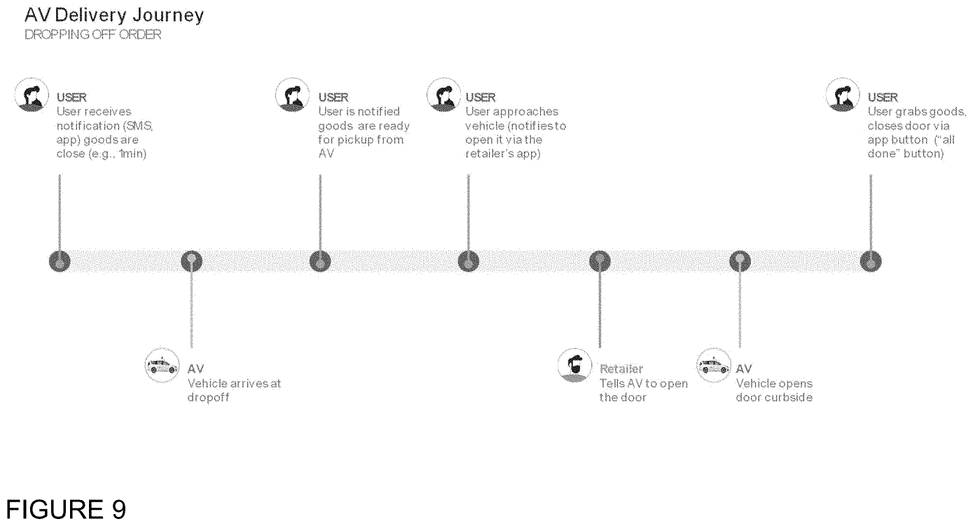

Turning to FIG. 9, the retail computing system 440 may also use the received information to determine when the autonomous vehicle is within a predetermined distance in time or space from the delivery location. As an example, this predetermined distance may include a predetermined amount of time, such as 1 minute or more or less, along the route. When the autonomous vehicle is determined to be within the predetermined distance in time or space from the delivery location, the retail computing system 440 may send a notification to the client computing device 420 indicating that the autonomous vehicle is within the predetermined distance from the delivery location for display to the user 422. This may in effect notify the user 422 that the autonomous vehicle is close to the delivery location.

Returning to FIG. 10, at block 1040, a second notification indicating arrival of the autonomous vehicle at the delivery location is received. In response, at block 1050, a third notification is sent to a client computing device indicating that the one or more goods has arrived at the delivery location. Returning to FIG. 9, once the autonomous vehicle arrives at the delivery location, the autonomous vehicle may send a notification to the dispatching computing system 410. The dispatching computing system 410, in turn, may send a notification of the same to the retail computing system 440.

In response to receiving this third notification from the dispatching computing system, a third notification is sent to a client computing device indicating that the one or more goods has arrived at the delivery location at block 1060. For instance, as shown in FIG. 9, the user 422 may be notified via the client computing device 420 that the one or more goods are ready for pickup from the autonomous vehicle, or rather that the autonomous vehicle has arrived at the delivery locations.

Thereafter, as shown in block 1070 of FIG. 10, in response to receiving the third request, a signal is sent to the second computing system in order to unlock or open the door and provide access to the one or more goods. For example, returning to FIG. 9, the user 422 may use the application or website on his or her computing device to send a request to the retail computing system 440 to open the doors of the autonomous vehicle. This request may cause the retail computing system 440 to send a similar request to the dispatching computing system 410. The dispatching computing system 410 may receive the request and send a signal to the autonomous vehicle in order to cause the autonomous vehicle to unlock and/or open one or more doors of the autonomous vehicle. At this point, the user 422 may retrieve the one or more goods from the autonomous vehicle.

In addition, the user 422 may also select an “all done” option, for example, via the application or website on the client computing device 420 or a button of the autonomous vehicle (such as user input 150), to confirm that the user 422 has retrieved the one or more goods. Selecting this option may dispatch or cause the autonomous vehicle to travel from the delivery location to some other location which may be determined by the dispatching computing system 410. In response, if using the client computing device 420, the application or website may send a notification indicating the same to the retail computing system 440 confirming that the user 422 has received the one or more goods. Alternatively, if a button within the autonomous vehicle is used, the autonomous vehicle may send a signal to the dispatching computing system 410 indicating that the autonomous vehicle is now traveling from the delivery location. In turn, the dispatching computing system 410 may send a notification of the same to the retail computing system 440 confirming that the autonomous vehicle is leaving or has left the delivery location. In the former case, the user 422 may close the door before selecting the option, and in the latter case, the user 422 may close the door after selecting the option.

The features described herein may provide a practical and efficient way to deliver goods to a user using autonomous vehicles.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method of providing deliveries of goods using autonomous vehicles, the method comprising:
receiving, by a first computing system, a first request for one or more goods for delivery, the first request further including a delivery location;
sending, by the first computing system, a second request to a second computing system for an autonomous vehicle to deliver the one or more goods, the second request identifying the delivery location;
receiving, by the first computing system, a first notification indicating that the autonomous vehicle has been loaded with the one or more goods at a loading location;
receiving, by the first computing system, a second notification indicating arrival of the autonomous vehicle at the delivery location;
in response to receiving the second notification, sending, by the first computing system, a third notification to a client computing device indicating that the one or more goods has arrived at the delivery location;
in response to sending the third notification, receiving, by the first computing system, a third request to open a door of the autonomous vehicle; and
in response to receiving the third request, sending, by the first computing system, a signal to the second computing system in order to unlock or open the door and provide access to the one or more goods.

2. The method of claim 1, further comprising, prior to sending the second request, determining an estimated time of arrival for a plurality of delivery options.

3. The method of claim 1, further comprising, providing to the client computing device, a plurality of delivery options including an option to receive delivery of the one or more goods by an autonomous vehicle.

4. The method of claim 3, further comprising, prior to sending the second request, receiving information corresponding to a selection of the option.

5. The method of claim 3, further comprising, determining that the option is available.

6. The method of claim 3, further comprising, prior to sending the second request, determining whether the delivery location is within a service area for the autonomous vehicle.

7. The method of claim 1, further comprising, receiving, from the second computing system, a fifth notification that the autonomous vehicle has been dispatched to the loading location.

8. The method of claim 7, further comprising, prior to receiving the second notification, receiving a fifth notification that the autonomous vehicle has arrived at the loading location.

9. The method of claim 7, further comprising, receiving, from the second computing system, information identifying an identifier for the autonomous vehicle.

10. The method of claim 9, further comprising, associating an order for the one or more goods with the identifier.

11. The method of claim 9, further comprising, providing the identifier to the client computing device for display to a user.

12. The method of claim 1, further comprising, receiving, from the second computing system, information identifying an estimated time of arrival for the autonomous vehicle to reach the delivery location.

13. The method of claim 12, further comprising, providing the estimated time of arrival to the client computing device for display to a user.

14. The method of claim 1, further comprising, receiving, from the second computing system, information identifying a current location of the autonomous vehicle and updates to the current location over time.

15. The method of claim 14, further comprising, based on the received current location and updates to the current location, determining when the autonomous vehicle is within a predetermined distance in time or space from the delivery location.

16. The method of claim 15, further comprising, when the autonomous vehicle is within the predetermined distance, sending a fourth notification to the client computing device.

17. The method of claim 14, further comprising, providing the current location and updates to the current location for display to a user.

18. The method of claim 1, further comprising, receiving a fourth notification that an operator at the loading location has selected an option to cause the autonomous vehicle to travel from the loading location to the delivery location.

19. The method of claim 18, wherein the option is a button within the autonomous vehicle.

20. The method of claim 18, wherein the option is provided via an application used by the operator.
